(19) United States
(12) Patent Application Publication
(10) Pub. No.: US 2009/0300736 A1
(43) Pub. Date: Dec. 3, 2009

(54) REMOTE ACCESS METHOD

(75) Inventors: Chih-Yi CHEN, Taipei (TW); Hsien-Kang WANG, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTek COMPUTER INC., Taipei (TW)

(21) Appl. No.: 12/468,649

(22) Filed: May 19, 2009

(30) Foreign Application Priority Data
May 30, 2008 (TW) 097120281

(51) Int. Cl. H04L 9/32; G06F 21/00

(52) U.S. Cl. 726/5

(57) ABSTRACT

A remote access method for use in a computer includes the following steps. Firstly, the computer logins into a remote access interface. Next, a remote access role of the computer is selected via the remote access interface, and a remote access operation is performed according to the selected remote access role. If the remote access role is intended to be changed, another remote access role of the computer is selected via the remote access interface.

### FIELD OF THE INVENTION

The present invention relates to a remote access method, and more particularly to an automatic remote access method via a remote access interface.

### BACKGROUND OF THE INVENTION

Remote access systems allow users to access a computer from a remote location by using a remote computer that has installed remote access software. For example, the users may use remote access systems to gain access to their computers from various remote locations such as branch offices, their homes, or while traveling. By the remote access systems, the users are allowed to utilize the database, the application software and the network resources of the office's computers even if the users are not at their offices.

Nowadays, the widely-used remote access functionality is a remote desktop functionality, which allows users to connect to a computer running Windows XP Professional. For executing the remote access functionality, a series of pre-preparation procedures should be done. The pre-preparation procedures will be illustrated in more details as follows. In the first pre-preparation procedure, Windows XP Professional is installed in the office computer (or server computer). In the second pre-preparation procedure, remote desktop connection client software is installed in the client computer (or remote computer). In the third pre-preparation procedure, the client computer is communicated with the server computer.

After the above pre-preparation procedures are performed, settings of the client computer and the server computer are implemented by the following steps. First of all, a new user account is created in the server computer. This user account has the administrator privilege. After the user account is created, the password of the user account is stored in the server computer and then the remote desktop functionality of the server computer is executed. Secondly, the remote desktop connection client software of the client computer is executed and then the name of the server computer is inputted. After the client computer is communicated with the server computer, the user account name of the client computer, the password and the domain name are successively inputted in order to login into the system to obtain access. After the user logins into the remote access system, a remote desktop window is opened in the client computer. At this moment, the user can view the desktop settings, files and programs of the sever computer by the client computer.

FIGS. 1A and 1B are flowcharts illustrating remote access methods implement by a client computer and a server computer according to the prior art. After the remote desktop functionality of the server computer is enabled, the client computer 10 and the server computer 100 login into the remote access system (Steps 11 and 101). Next, associated parameters of the client computer 10 and the server computer 100 are set (Steps 12 and 102). Next, a client interface 13 of the client computer 10 is connected with a sever interface 103 of the server computer 100 such that the client computer 10 is communicated with the server computer 100 (Steps 13 and 103). After the client computer 10 is communicated with the server computer 100, the remote access operations are performed (Steps 14 and 104). After the remote access operations are performed, the user may decide whether the remote access method is terminated (Steps 15 and 105). Meanwhile, the remote access method is terminated (Steps 16 and 106) or otherwise returned to the Steps 11 and 101.

From the above discussion, the method for allowing the client computer to access the sever computer needs to login into the remote access system through the client computer and the server computer. In addition, complicated and trivial steps are required in order to communicate the client computer with the server computer. The complicated setting steps become hindrance from sharing resources for the users that are not well-educated. Moreover, the login step needs to be performed again after the remote access operations are performed. The conventional remote access method is not user-friendly.

### SUMMARY OF THE INVENTION

In accordance with an aspect of the present invention, there is provided a remote access method for use in a computer. Firstly, the computer logins into a remote access interface. Next, a remote access role of the computer is selected via the remote access interface, and a remote access operation is performed according to the selected remote access role. If the remote access role is intended to be changed, another remote access role of the computer is selected via the remote access interface.

In accordance with another aspect of the present invention, there is provided a remote access method for use in a first computer and a second computer. The remote access method includes steps of allowing the first computer and the second computer to login into a remote access interface, selecting the first computer as a first remote access role via the remote access interface, selecting the second computer as a second remote access role via the remote access interface, and allowing the first computer and the second computer to performing corresponding remote access operations according to the selected first and remote access roles.

By the remote access method of the present invention, the computer can automatically login into the remote access system and the remote access settings can be automatically implemented. In addition, after the remote access operation is done, the role selection procedure can be performed again without the need of performing the login procedure.

### BRIEF DESCRIPTION OF THE DRAWINGS

The above contents of the present invention will become more readily apparent to those ordinarily skilled in the art after reviewing the following detailed description and accompanying drawings, in which:

FIGS. 1A and 1B are flowcharts illustrating remote access methods implement by a client computer and a server computer according to the prior art; and

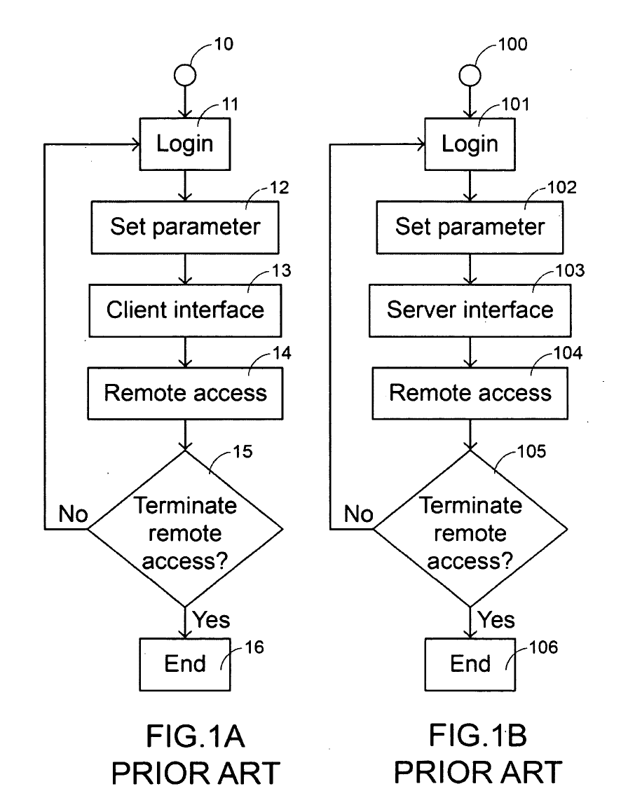

FIG. 2 is a flowchart illustrating a remote access method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

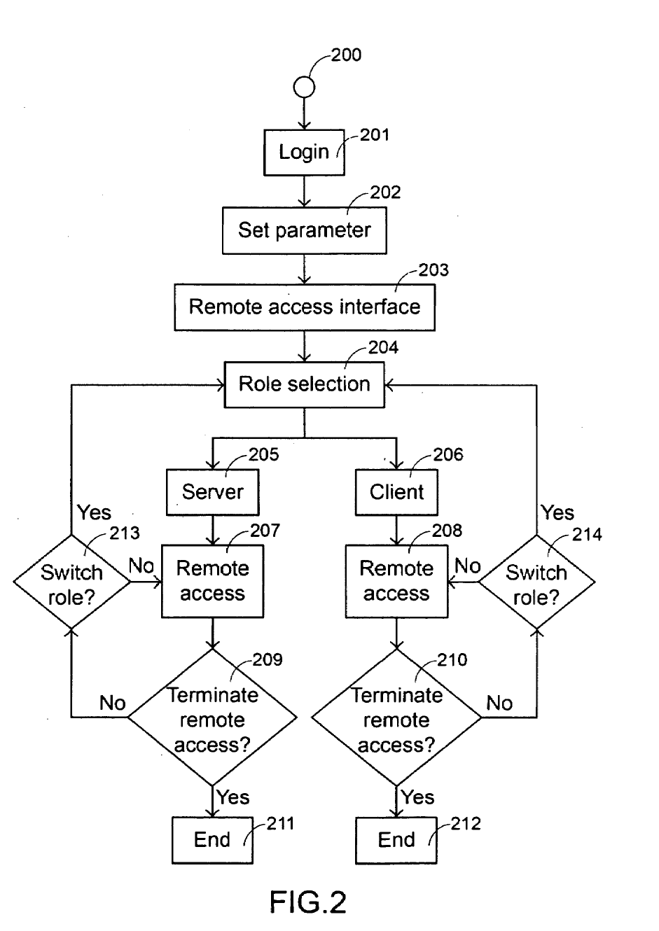

FIG. 2 is a flowchart illustrating a remote access method according to an embodiment of the present invention. First of all, a computer 200 is connected to the Internet and then the remote access functionality is enabled. After remote access functionality is enabled, the computer 200 logins into the remote access system (Step 201). The present invention has an auto-login function. In other words, the user account number and the password have been previously stored in an auto-login tool. The computer 200 may easily login into the remote access system by the auto-login tool. Alternatively, the user may manually input the user account number and the password in order to login into the remote access system. Next, associated parameters of the computer 200 are automatically set (Step 202). Next, the computer 200 is connected to a shared remote access interface (Step 203). As previously described in the prior art, the server computer and the client computer are respectively connected the sever interface and the client interface. According to the present invention, the computer 200 needs to be connected to the shared remote access interface, because the sever interface and the client interface are integrated into the shared remote access interface. After the computer 200 is connected to the shared remote access interface, a role selection procedure is performed (Step 204). The prevent invention provides a role selector to select the remote access role of the computer 200. According to the selected remote access role, the computer 200 will set associated functions and perform related remote access operations. In a case that the computer 200 is selected as a server computer (Step 205), the computer 200 will set associated functions and perform related remote access operations according to the selected remote access role as the server computer (Step 207). After the remote access operations are performed, the user may decide whether the remote access method is terminated (Step 209). Meanwhile, the remote access method is terminated (Step 211) or otherwise returned to the Step 213. In the Step 213, the user may decide whether the remote access role is switched and changed. If the remote access role is not changed, the Step 207 is repeated done. On the other hand, if the remote access role needs to be switched and changed, the role selection procedure is performed again (Step 204). In a case that the computer 200 is selected as a client computer (Step 206), the computer 200 will set associated functions and perform related remote access operations according to the selected remote access role as the client computer (Step 208). After the remote access operations are performed, the user may decide whether the remote access method is terminated (Step 210). Meanwhile, the remote access method is terminated (Step 212) or otherwise returned to the Step 214. In the Step 214, the user may decide whether the remote access role is switched and changed. If the remote access role is not changed, the Step 208 is repeated done. On the other hand, if the remote access role needs to be switched and changed, the role selection procedure is performed again (Step 204).

Hereinafter, a process of implementing the remote access method between two personal computers will be illustrated in more details.

First of all, a first personal computer and a second computer are connected to the Internet and then the remote access functionality is enabled. After remote access functionality is enabled, the first personal computer and the second computer login into the remote access system (Step 201). In this embodiment, the first personal computer and the second computer can automatically login into the remote access system by auto-login tools. After the first personal computer and the second computer login into the remote access system, associated parameters of the first personal computer and the second computer login into the remote access system are automatically set (Step 202). Next, the first personal computer and the second computer are connected to the shared remote access interface (Step 203) and then a role selection procedure is performed (Step 204). By the role selector, the first computer is selected as a server computer (Step 205) and the second computer is selected as a client computer (Step 206). Next, the first personal computer and the second computer will set associated functions and perform related remote access operations according to the selected remote access role (Steps 207 and 208). Meanwhile, the second computer selected as the client computer is connected with the first computer selected as the server computer and related remote access operations are performed. After the remote access operations are performed, the user may decide whether the remote access method is terminated (Steps 209 and 210). Meanwhile, the remote access method is terminated (Steps 211 and 213) or otherwise returned to the Steps 213 and 214. In the Steps 213 and 214, the user may decide whether the remote access roles of the first and second computers are exchanged. If the remote access roles of the first and second computers need to be exchanged, the role selection procedure is performed again (Step 204) without the need of performing the login procedure.

From the above description, the computer can easily login into the remote access system by the auto-login tool according to the remote access method of the present invention. Moreover, since a sever interface and a client interface are integrated into the remote access interface, the remote access role of the computer can be selected or changed via the remote access interface without the need of logout. According to the selected remote access role, associated functions are set and the remote access operation is performed. As previously described in the conventional remote access method, complicated setting steps are required and the login step needs to be performed again if the roles of the server computer and the client computer are intended to be exchanged. In accordance with the remote access method of the present invention, the computer can automatically login into the remote access system and the remote access settings can be automatically implemented. In addition, after the remote access operation is done, the role selection procedure can be performed again without the need of performing the login procedure. In comparison with prior art, the remote access method of the present invention is more user-friendly.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remote access method for use in a computer, the remote access method comprising steps:
allowing the computer to login into a remote access interface;
selecting a remote access role of the computer via the remote access interface and performing a remote access operation according to the selected remote access role; and
selecting another remote access role of the computer via the remote access interface if the remote access role is intended to be changed.

2. The remote access method according to claim 1 wherein the remote access role of the computer includes a client computer or a server computer.

3. The remote access method according to claim 1 wherein after the remote access role is selected, associated functions are set and the remote access operation is performed according to the selected remote access role.

4. The remote access method according to claim 1 wherein a first data is previously stored in the computer such that the computer automatically logins into the remote access interface by the first data, or the first data is manually inputted in the computer such that the computer logins into the remote access interface by the first data.

5. The remote access method according to claim 4 wherein the first data includes a user account number and a user password.

6. A remote access method for use in a first computer and a second computer, the remote access method comprising steps:
allowing the first computer and the second computer to login into a remote access interface;
selecting the first computer as a first remote access role via the remote access interface;
selecting the second computer as a second remote access role via the remote access interface; and
allowing the first computer and the second computer to performing corresponding remote access operations according to the selected first and remote access roles.

7. The remote access method according to claim 6 wherein the first remote access role is a client computer, and the second remote access role is a server computer.

8. The remote access method according to claim 6 wherein after the first and second remote access roles are selected, associated functions are set and the remote access operations are performed according to the selected first and second remote access roles.

9. The remote access method according to claim 6 wherein a first data is previously stored in the first and second computers such that the first and second computer automatically logins into the remote access interface by the first data, or the first data is manually inputted in the first and second computers such that the first and second computers computer logins into the remote access interface by the first data.

10. The remote access method according to claim 9 wherein the first data includes a user account number and a user password.

11. The remote access method according to claim 6 wherein after the remote access operations are performed according to the selected first and second remote access roles, the first computer is selected as the second remote access role and the second computer is selected as the first remote access role.
